(19) United States
(12) Patent Application Publication
(10) Pub. No.: US 2026/0153408 A1
(43) Pub. Date: Jun. 4, 2026

(54) TEST DEVICE FOR INJECTION NOZZLES OF NUCLEAR POWER PLANT EMERGENCY GENERATORS

(71) Applicant: Bo Eok KIM, Pohang-si (KR)

(72) Inventors: Bo Eok KIM, Pohang-si (KR); Myoung Je KIM, Pohang-si (KR)

(21) Appl. No.: 19/407,449

(22) Filed: Dec. 3, 2025

(30) Foreign Application Priority Data
Dec. 4, 2024 (KR) 10-2024-0178918

(51) Int. Cl. G01M 15/04; G01M 15/02; G21D 1/02

(52) U.S. Cl. CPC G01M 15/042; G01M 15/02; G21D 1/02

(57) ABSTRACT

A test device for an injection nozzle of a nuclear power plant emergency generator that operates in an emergency situation of nuclear power generation includes a support table, a test body slidably installed on the support table and configured to slide between an inspection position and a storage position, a hydraulic pump arranged within the test body and configured to operate by pneumatic pressure, a first pneumatic line connecting an air inlet portion to the hydraulic pump and configured to supply air at a predetermined pressure to the hydraulic pump, a relief valve arranged on the first pneumatic line and configured to control a maximum pressure of the air, a hydraulic line configured to supply oil supplied by the hydraulic pump to an injection nozzle, and an oil pressure measuring portion configured to measure a pressure of oil flowing within the hydraulic line, wherein the oil pressure measuring portion comprises a digital display portion configured to measure a real-time pressure of the oil and digitally display a peak value of the oil pressure supplied to the injection nozzle.

### TECHNICAL FIELD

The present disclosure relates to a test device for an injection nozzle of a nuclear power plant emergency generator, and more particularly, to a test device for an injection nozzle of a nuclear power plant emergency generator to easily and quickly inspect abnormalities in the injection nozzle.

### BACKGROUND ART

An emergency diesel generator (EDG) installed in a nuclear power plant is a critical device that may be activated within approximately 10 seconds in the event of an emergency, such as a power outage or loss of external power, and may take over the emergency load within a minute to remove residual heat from a nuclear reactor and supply emergency power to key plant safety system components.

FIG. 1 is a schematic diagram illustrating a structure related to a volumetric fuel injection system, which is a type of diesel engine fuel injection system and in which a certain amount of fuel is pushed by a plunger and injected at high speed into a combustion chamber from an injection valve.

Fuel oil flowing into a plunger chamber 102 through an intake port 101 begins to be pressurized as a plunger 103, raised by a fuel cam, blocks the intake port 101 and a control port (discharge port). The pressure in the plunger chamber 102 continuously increases while the plunger 103 rises, and when the pressure of the pressurized fuel inside the plunger chamber 102 is greater than a delivery valve spring force and a fuel injection valve needle valve spring force, the fuel is injected through the end of an injection nozzle 105. Thereafter, when the pressure in the plunger chamber 102 decreases at the end of the fuel injection, a delivery valve 104 automatically closes due to the spring tension, thereby terminating the fuel injection.

Because the emergency diesel generator is not used in normal times but only in emergencies, regular maintenance is essential. In particular, the injection nozzle 105 must inject fuel at high speed through the discharge port. However, if not used for a long period of time, the injection nozzle 105 may be clogged by fuel adhesion or foreign materials or may not open accurately at the set pressure due to changes in the spring tension. Therefore, the injection nozzle must be regularly inspected to ensure that it accurately injects fuel at the appropriate pressure.

Conventional inspection of the injection nozzle 105 is performed by having a worker supply oil to the injection nozzle 105 by using a manual hand pump, gradually increasing the pressure of the oil, and visually checking the pressure at the moment when the oil is discharged (sprayed) by using an analog gauge (pressure gauge). When the oil is discharged from the nozzle in a spray form, the pressure in a hydraulic line drops rapidly, and the maximum pressure (injection start pressure) at this time is used as an operating pressure and compared to a reference value to determine any abnormalities.

However, this conventional manual testing method presents several problems.

First, conventional emergency generators are configured with multi-cylinder engines, requiring a significant number of injection nozzles to be inspected. The existing method requires an operator to manually operate a manual lever repeatedly to generate high pressure (hundreds of bars), which is extremely physically demanding, and excessive time and effort are required to inspect a large number of nozzles.

Second, conventional emergency generators involve manual pumping, which may result in inconsistent pressurization rates depending on the operator's skill level and fatigue. Differences in pressurization rates may have a subtle impact on the timing of nozzle opening, leading to errors in accurate injection pressure measurements.

Third, in the case of conventional emergency generators, at the moment the injection nozzle opens and fuel is injected, the gauge needle reaches its peak and the pressure drops in an instant. Because the operator must visually capture the peak of the fluctuating analog needle, errors in measurement values may easily occur depending on the operator's reaction time and viewing angle. This reduces the objectivity of inspection results and is a major cause of data discrepancies between operators.

Therefore, a new type of test device is needed to pressurize fuel at a constant rate while reducing the physical burden on the operator, accurately capture the peak injection pressure value that passes in an instant, and provide objective data.

### DISCLOSURE

### Technical Problem

The present disclosure is to solve the above-described problems. The technical objective of the present disclosure is to provide a test device for an injection nozzle of a nuclear power plant emergency generator to pressurize fuel at a constant rate while reducing the physical burden on the operator, accurately capture the peak injection pressure value that passes in an instant, and provide objective data.

### Technical Solution

In order to achieve the above-described technical objective, a test device for an injection nozzle of a nuclear power plant emergency generator, according to the present disclosure, is provided.

The test device for an injection nozzle of a nuclear power plant emergency generator configured to operate in an emergency situation of nuclear power generation includes:
a support table;
a test body slidably installed on the support table and configured to slide between an inspection position and a storage position;
a hydraulic pump arranged within the test body and configured to operate by pneumatic pressure;
a first pneumatic line connecting an air inlet portion to the hydraulic pump and configured to supply air at a predetermined pressure to the hydraulic pump;
a relief valve arranged on the first pneumatic line and configured to control a maximum pressure of the air;
a hydraulic line configured to supply oil from the hydraulic pump to an injection nozzle; and
an oil pressure measuring portion configured to measure a pressure of the oil flowing within the hydraulic line,
wherein the oil pressure measuring portion includes
a digital display portion configured to measure a real-time pressure of the oil and digitally display a peak value of the pressure of the oil supplied to the injection nozzle.

In the test device for an injection nozzle of a nuclear power plant emergency generator,
the pressure of the oil supplied by the hydraulic pump may gradually increase and then decrease after the oil supplied to the injection nozzle at a peak pressure is sprayed from the injection nozzle, and
the digital display portion may display the real-time pressure of the oil, and when the pressure of the oil increases and then decreases, only a peak value may be displayed and a decreasing pressure may not be displayed.

In the test device for an injection nozzle of a nuclear power plant emergency generator,
the oil pressure measuring portion may further include
an analog display portion configured to display the oil pressure in real time by using a needle,
wherein the analog display portion may be configured to reflect all increases and decreases in the oil pressure in real time.

In the test device for an injection nozzle of a nuclear power plant emergency generator,
a bypass line connected to an oil tank may be connected to the hydraulic line, and a control valve configured to control the pressure of the oil may be located in the bypass line.

In the test device for an injection nozzle of a nuclear power plant emergency generator,
the control valve may be connected to a pneumatic cylinder and configured to be opened and closed.

The test device for an injection nozzle of a nuclear power plant emergency generator
may further include a second pneumatic line connecting the air inlet portion to the pneumatic cylinder, wherein a second solenoid valve configured to selectively open and close air may be provided in the second pneumatic line.

In the test device for an injection nozzle of a nuclear power plant emergency generator,
on the first pneumatic line,
a pneumatic pressure measuring portion configured to measure air pressure may be provided.

In the test device for an injection nozzle of a nuclear power plant emergency generator,
the test body may include a discharge portion connected to the hydraulic line and configured to discharge oil,
an inspection portion facing the discharge portion and configured to perform nozzle inspection, and
a grip portion arranged above the inspection portion, protruding from the test body, and configured to grip the injection nozzle.

The test device for an injection nozzle of a nuclear power plant emergency generator may further include
a rail provided on the support table and extending longitudinally in one direction, and
a slider arranged below the test body and slidably coupled to the rail.

In the test device for an injection nozzle of a nuclear power plant emergency generator,
the support table
may have a plurality of storage grooves formed to accommodate a plurality of injection nozzles.

### Advantageous Effects

The present disclosure eliminates the inconvenience of the existing manual pumping method by employing a hydraulic pump driven by pneumatic pressure. Therefore, operators do not need to perform repetitive physical labor to form high pressure, which significantly reduces fatigue. In particular, in cases where injection nozzles of emergency generators having a plurality of cylinders, as in nuclear power plants, must be fully inspected, there is the effect of drastically reducing inspection time, enabling rapid maintenance work.

The present disclosure may increase oil pressure at a constant and stable rate by using a hydraulic pump driven by pneumatic pressure. This eliminates errors caused by differences in pressurization speed when measuring the opening pressure of an injection nozzle, thereby ensuring consistency and reliability of measured data.

The present disclosure includes a digital display portion that automatically captures and displays a peak pressure at the moment (the cracking point) the injection nozzle performs injection. Even when the pressure rapidly drops immediately after the oil injection, a peak value remains on a digital display, thereby preventing operators from missing the momentary needle movement or misreading due to parallax that occurs when reading the scale. This allows for objective and accurate judgment, thereby enhancing maintenance quality.

The present disclosure provides both a digital display portion that displays precise values and an analog display portion that intuitively displays pressure fluctuations. Operators may check accurate injection pressure values through the digital display portion, and may also comprehensively monitor a pressure rise pattern during a pressurization process or a pressure holding status after injection through the needle movement of the analog display portion. This is useful not only for simple nozzle opening pressure but also for identifying abnormalities, such as needle valve sticking or minor oil leaks (dribbling), from various angles.

The present disclosure opens a bypass line through pneumatic control without any separate operation after the inspection is completed, thereby allowing for rapid removal of residual pressure within a hydraulic line and safe return of oil to a tank. This prevents contamination of the work environment due to oil scattering and reduces preparation time for the next inspection.

### DESCRIPTION OF DRAWINGS

FIG. 1 is a schematic diagram illustrating an injection system for typical nuclear power plant emergency power generation.

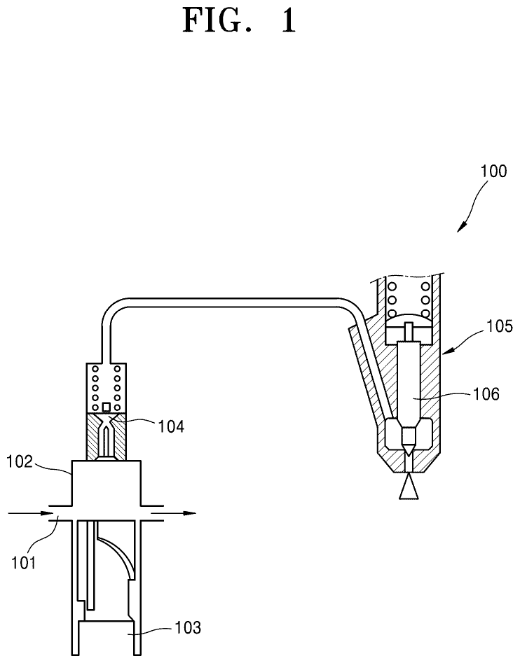

FIG. 2 is a front view of an injection nozzle test device according to the present disclosure.

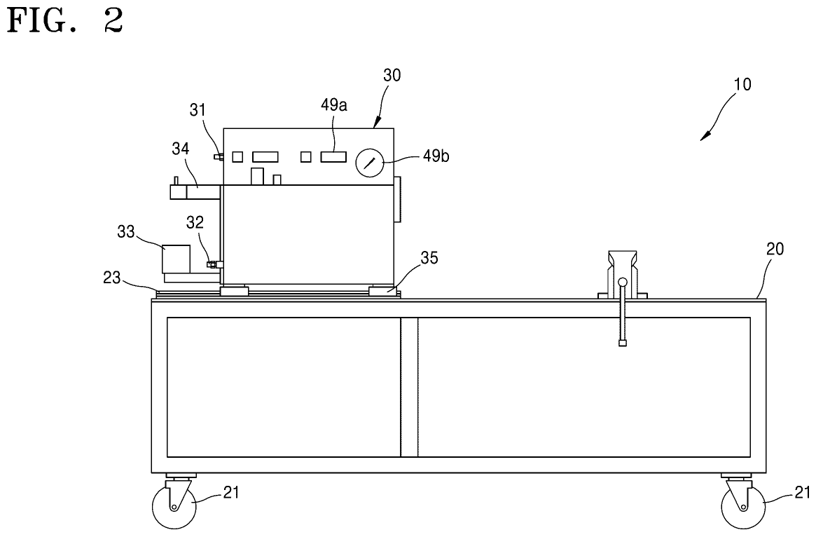

FIG. 3 is a plan view of the injection nozzle test device of FIG. 2.

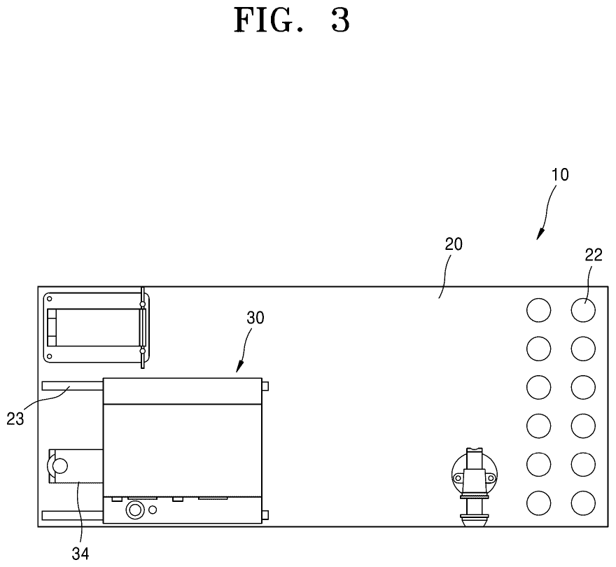

FIG. 4 is a side view of the injection nozzle test device of FIG. 2.

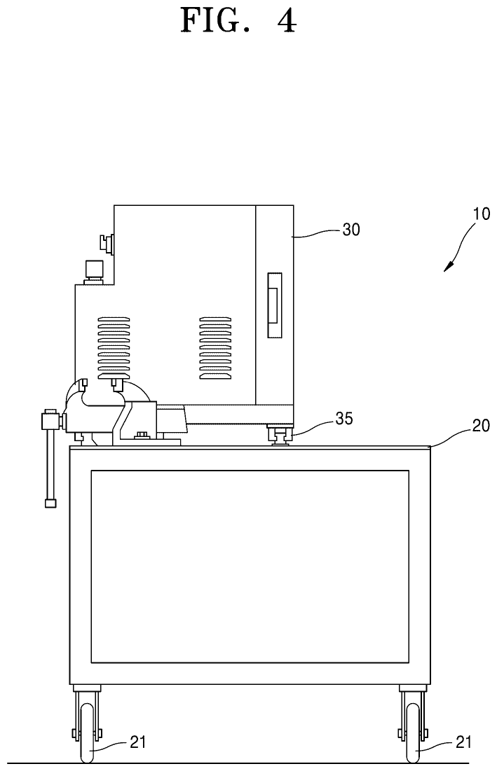

FIG. 5 is an enlarged view of a portion of FIG. 2.

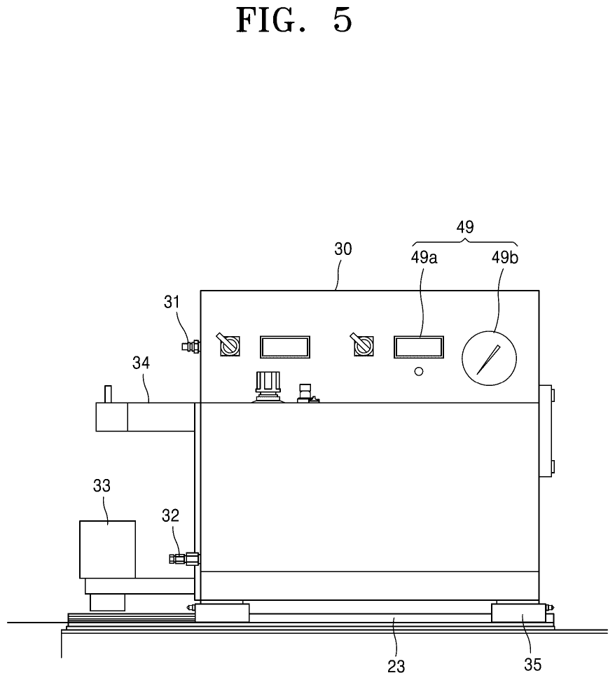

FIG. 6 is a hydraulic circuit diagram of the injection nozzle test device of FIG. 2.

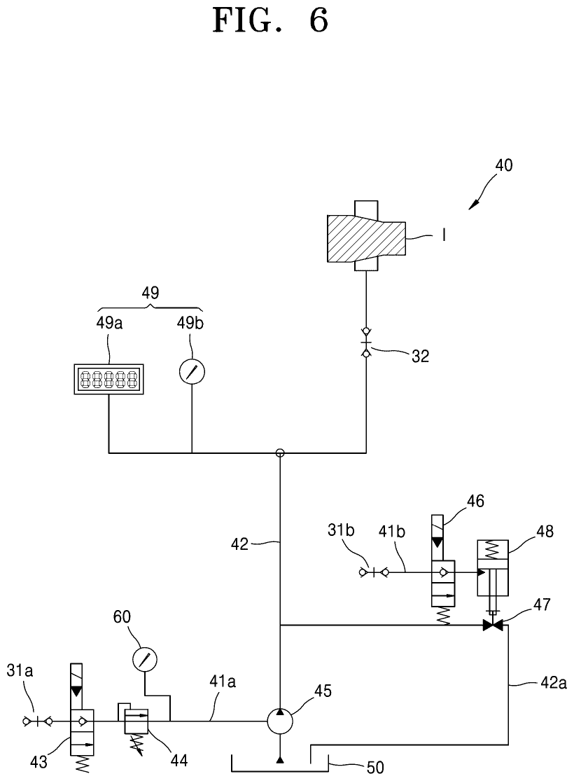

### DETAILED DESCRIPTION OF THE EMBODIMENTS

The present specification clarifies the scope of rights of the present disclosure, and describes the principles of the present disclosure and discloses embodiments such that one of ordinary skill in the art to which the present disclosure pertains may work the present disclosure. The disclosed embodiments may be implemented in various forms.

The terms “include” or “may include”, etc. which may be used in various embodiments of the present disclosure indicate the presence of the corresponding function, operation or element that are disclosed, and do not limit one or more additional functions, operations, or elements, etc. In addition, in various embodiments of the present disclosure, the terms “include” or “have” should be construed to designate the presence of a feature, number, step, operation, component, or a combination thereof described in the specification, and not to exclude, in advance, the presence or the possibility of addition of one or more other features, numbers, steps, operations, elements, components, or a combination thereof.

When it is mentioned that an element is “connected or coupled” to another element, it should be construed that the element may be directly connected or coupled to the other element, but another new element may be present between the element and the other element. On the other hand, when it is mentioned that an element is “directly connected” or “directly coupled” to another element, it should be construed that no new element is present between the element and the other element.

The terms “first”, “second”, etc. used in the present specification may be used to describe various elements, but the elements should not be limited by those terms. The terms are only used for the purpose of distinguishing one element from another element.

The present disclosure relates to an emergency generator used in a nuclear power plant. Specifically, a nuclear power plant is largely composed of a nuclear reactor, a pressurizer, a steam generator, a turbine/generator, and a condenser. In addition, various control devices and safety equipment are installed to ensure the nuclear reactor's safe operation. The nuclear reactor uses the heat generated through nuclear fission in nuclear fuel to heat a coolant to a temperature of approximately 320° C. The pressurizer maintains a high pressure of approximately 150 atmospheres to prevent the nuclear reactor's coolant from boiling. The steam generator produces steam through heat exchange with high-temperature and high-pressure water. The turbine/generator converts the steam energy into electrical energy. The condenser cools the steam, which has generated electricity, with seawater or river water through heat exchange and returns the cooled steam to the steam generator.

When the nuclear power plant malfunctions and shuts down, the temperature inside the nuclear reactor rapidly rises. In this case, to cool the nuclear reactor, which has been heated by nuclear fission, boric acid is injected. Additionally, emergency power generation is implemented to operate essential safety devices, to maintain the power plant's safety, such as removing decay heat after a nuclear reactor shutdown. Emergency diesel generators and storage batteries are installed as emergency power sources, each with redundancy and independence.

The emergency diesel generator is not used during normal operation and operates only during emergencies, requiring regular maintenance. The emergency diesel generator is equipped with an injection nozzle. The injection nozzle requires periodic inspection. When a certain oil pressure is applied to the injection nozzle, a nozzle inlet must be opened to spray oil in the form of a fine mist. Because the nozzle may become stuck inside and fail to operate at the required pressure, it is necessary to check that the oil is sprayed at the preset oil pressure. During the test, the oil pressure at the point of spraying is measured and compared to the preset appropriate oil pressure. When the measured pressure differs from the appropriate pressure, the injection nozzle is replaced.

The present disclosure relates to a test device for checking whether the spray pressure of an injection nozzle is within an appropriate range.

A test device 10 for an injection nozzle of a nuclear power plant emergency generator, according to the disclosure, may include a support table 20, a test body 30, and a hydraulic system 40.

The support table 20 is provided with the hydraulic system 40 including the test body 30 installed on an upper portion thereof. Wheels 21 are installed at the bottom of the support table 20 to enable movement of the test device 10.

The test body 30 is slidably installed on one side of the support table 20. A storage groove 22 is formed in the other side of the support table 20 to accommodate a plurality of injection nozzles I.

Specifically, a rail 23 is provided on one side of the support table 20 to allow the test body 30 to be slidably installed. The rail 23 extends along a longitudinal direction of the support table 20 and guides the test body 30 to slide between an inspection position and a storage position. As the test body 30 slides between the inspection position and the storage position, the test body 30 is configured to move to the inspection position when inspection is required, thereby preventing damage to the test device 10.

A plurality of storage grooves 22 are arranged on the other side of the support table 20. Each of the storage grooves 22 is configured to accommodate one injection nozzle I. Because an injection nozzle I requiring inspection may be separately accommodated on the support table 20, rapid inspection is possible.

The test body 30 is slidably installed on the support table 20 and slides between the inspection position and the storage position. The hydraulic system 40 is installed within the test body 30. The test body 30 is formed in a hexahedral shape. A lower portion of the test body 30 is slidably connected to the rail 23. Specifically, a slider 35 is provided below the test body 30. The slider 35 is slidably connected to the rail 23. As the slider moves along the rail 23, the test body 30 also slides along the rail 23.

An air inlet portion 31, a discharge portion 32, an inspection portion 33, and a grip portion 34 are provided on one side of the test body 30.

The air inlet portion 31 is connected to an external pneumatic line and allows air at a predetermined pressure to be introduced. The air inlet portion 31 is formed at the upper end of one side of the test body 30. An air inlet hose (not shown) is connected to the air inlet portion 31. Air supplied through the air inlet portion 31 flows into a first pneumatic line 41a and a second pneumatic line 41b.

The discharge portion 32 is a portion from which pressurized oil is discharged. The discharge portion 32 is connected to a hydraulic line 42. The discharge portion 32 is formed at the lower portion of one side of the test body 30. The discharge portion 32 includes a quick coupler. The quick coupler connects an external hydraulic hose to the discharge portion 32 with one-touch. The hydraulic hose connected to the discharge portion 32 is connected to the injection nozzle I. The injection nozzle I accommodated in the inspection portion 33 is inspected using oil supplied through the hydraulic hose.

The inspection portion 33 faces the discharge portion 32 and is used for nozzle inspection. The inspection portion 33 protrudes from one side of the test body 30. The inspection portion 33 is installed in the test body 30 and extends outward. The injection nozzle I is inserted into the inspection portion 33. The injection nozzle I may be connected to a hydraulic hose connected to the discharge portion 32. The injection nozzle I sprays oil within the inspection portion 33. Oil sprayed from the injection nozzle I is stored within the inspection portion 33. After a certain amount of oil is filled, the oil may be removed. The inspection portion 33 may be installed to face the discharge portion 32.

The grip portion 34 grips the upper end of the injection nozzle I. The grip portion 34 is arranged at the upper end of one side of the test body 30. The grip portion 34 is arranged above the inspection portion 33. The grip portion 34 protrudes outward from the upper end of one side of the test body 30. The grip portion 34 detachably fixes the injection nozzle I. A hydraulic hose is connected to the injection nozzle I fixed to the grip portion 34. The injection nozzle I that has undergone inspection is detached from the grip portion 34 and replaced with a new injection nozzle.

The hydraulic system 40 is arranged within the test body 30 to discharge oil at high pressure by using air. The hydraulic system 40 includes the first pneumatic line 41a, the second pneumatic line 41b, the hydraulic line 42, a bypass line 42a, a first solenoid valve 43, a relief valve 44, a hydraulic pump 45, a second solenoid valve 46, a control valve 47, a pneumatic cylinder 48, and an oil pressure measuring portion 49.

The first pneumatic line 41a connects the air inlet portion 31 to the hydraulic pump 45 to supply air of a predetermined pressure to the hydraulic pump 45. One side of the first pneumatic line 41a is connected to the air inlet portion 31.

The air inlet portion 31 may be formed with a quick coupler structure that offers excellent workability. This allows the operator to attach and detach a pneumatic hose with a single touch, without tools, thereby reducing line replacement time during the process of continuously inspecting multiple injection nozzles I.

Specifically, the air inlet portion 31 may include a first quick coupler 31a connected to the first pneumatic line 41a and a second quick coupler 31b connected to the second pneumatic line 41b. The first and second quick couplers 31a and 31b are connected to a pneumatic hose connected to an external air supply source, thereby supplying air to the hydraulic pump 45 and the pneumatic cylinder 48.

The other end of the first pneumatic line 41a is connected to the hydraulic pump 45. High-pressure air flows through the first pneumatic line 41a. The first pneumatic line 41a is provided with the first solenoid valve 43, the relief valve 44, and a pneumatic pressure measuring portion 60.

Furthermore, the pneumatically driven hydraulic pump 45 employed in the present disclosure has a characteristic of having a virtually constant pressure increase ratio between the input air pressure and the discharged oil pressure. Therefore, by checking the air pressure displayed on the pneumatic pressure measuring portion 60, the operator may indirectly predict the maximum hydraulic pressure that may be generated by the hydraulic pump 45, and may more precisely set and manage the test pressure to be applied to the injection nozzle I.

The pneumatic pressure measuring portion 60 is preferably provided in the form of an analog pressure gauge and installed in a location easily visible to the operator, such as the front panel of the test body 30. However, if necessary, the pneumatic pressure measuring portion 60 may be configured to include an electric pressure sensor and a display device to be linked with a digital display portion 49a, or configured to transmit measured values to a data recording device, if necessary.

The second pneumatic line 41b connects the air inlet portion 31 to the pneumatic cylinder 48. One side of the second pneumatic line 41b is connected to the air inlet portion 31. The other side of the second pneumatic line 41b is connected to the pneumatic cylinder 48. High-pressure air flows through the second pneumatic line 41b. The second solenoid valve 46 is connected to the second pneumatic line 41b.

The hydraulic line 42 supplies oil supplied by the hydraulic pump 45 to the injection nozzle I. One side of the hydraulic line 42 is immersed in an oil tank 50. The other side of the hydraulic line 42 is connected to the discharge portion 32. Oil stored in the oil tank 50 changes into a high-pressure oil as the oil passes through the hydraulic pump 45, and the high-pressure oil moves along the hydraulic line 42 and is supplied to the injection nozzle I.

The bypass line 42a is connected to the hydraulic line 42 to allow some of the oil to be returned to the oil tank 50. The oil pressure measuring portion 49 may be provided in the hydraulic line 42 to measure the pressure of the oil flowing through the hydraulic line 42.

The bypass line 42a branches off from the hydraulic line 42. The bypass line 42a branched from the hydraulic line 42 is connected to the oil tank 50. Specifically, the bypass line 42a separated from the hydraulic line 42 allows the oil to be returned to the oil tank 50. When some of the oil is retrieved through the bypass line 42a, the pressure and flow rate of the oil flowing through the hydraulic line 42 may be controlled.

The oil tank 50 holds approximately 4 liters of oil. The oil tank 50 is connected to the hydraulic line 42 and supplies oil to the hydraulic pump 45. The oil tank 50 stores oil retrieved through the bypass line 42a.

The first solenoid valve 43 is provided on the first pneumatic line 41a. The first solenoid valve 43 opens and closes the first pneumatic line 41a by using an electrical signal. When the first solenoid valve is off, the first pneumatic line 41a is closed, preventing air from being supplied to the hydraulic pump 45. When the first solenoid valve 43 is on, air is supplied to the hydraulic pump 45, thereby allowing the hydraulic pump 45 to operate.

The relief valve 44 is arranged on the first pneumatic line 41a and controls the maximum air pressure. The relief valve 44 is arranged between the first solenoid valve 43 and the hydraulic pump 45, more specifically, between the first solenoid valve 43 and the pneumatic pressure measuring portion 60. The relief valve 44 regulates the pressure of externally supplied air.

When excessive air pressure is supplied to the hydraulic pump 45, the hydraulic pump 45 may be damaged, but the relief valve 44 prevents this. Furthermore, the relief valve 44 ensures that air is supplied to the hydraulic pump 45 at a constant pressure, thereby maintaining a constant oil pressure.

The pneumatic pressure measuring portion 60 is arranged, on the first pneumatic line 41a, between the relief valve 44 and the hydraulic pump 45. The pneumatic pressure measuring portion 60 measures and displays, in real time, the pressure (driving pressure) of the air actually supplied to the hydraulic pump 45 through the relief valve 44.

More specifically, because the pneumatic pressure measuring portion 60 is arranged at the rear end of the relief valve 44, the operator may accurately visually check the final air pressure regulated by the relief valve 44. When the pneumatic pressure measuring portion 60 is arranged at the front end of the relief valve 44, only the source pressure on the air inlet portion 31 side, not the actual pressure flowing into the hydraulic pump 45, is measured, making precise control of the driving pressure using the relief valve 44 difficult. To prevent this problem, in the present disclosure, the pneumatic pressure measuring portion 60 is arranged between the relief valve 44 and the hydraulic pump 45, thereby enabling the input conditions of the hydraulic pump 45 to be clearly identified.

The pneumatic pressure measuring portion 60 displays an actual driving pneumatic pressure input to the hydraulic pump 45 along the first pneumatic line 41a after passing through the relief valve 44, thereby providing a reference value for pressure control. Here, the “reference value for pressure control” refers to an air pressure value that must be applied to the hydraulic pump 45 to generate a target oil pressure (oil discharge pressure). That is, in the present disclosure, instead of directly relieving high-pressure oil pressure reaching several hundred bar in the hydraulic line 42, the driving pneumatic pressure is controlled through the relief valve 44 and the pneumatic pressure measuring portion 60 on the relatively low-pressure air side, thereby providing a technical advantage in that the operator may adjust the test pressure with less force and in fine units.

The hydraulic pump 45 is arranged within the test body 30 and is operated by pneumatic pressure. Because the hydraulic pump 45 operates by pneumatic pressure, the oil pressure may be precisely controlled and may respond to a desired oil pressure.

The hydraulic pump 45 is connected to the hydraulic line 42. The hydraulic pump 45 draws oil from the oil tank 50 and increases the pressure of the oil.

The hydraulic pump 45 is connected to the first pneumatic line 41a and is configured to rotate gears by air. The gears within the hydraulic pump 45 increase the pressure of the oil flowing along the hydraulic line 42. In the present embodiment, the hydraulic pump 45 may increase the oil pressure to approximately 500 bar.

The second solenoid valve 46 is provided on the second pneumatic line 41b and determines whether air is supplied to the pneumatic cylinder 48. The second solenoid valve 46 opens and closes the second pneumatic line 41b by using an electrical signal. When the second solenoid valve 46 is in the off state, the second pneumatic line 41b is closed, and air is not supplied to the pneumatic cylinder 48. When the second solenoid valve 46 is in the on state, air is supplied to the pneumatic cylinder 48, causing the pneumatic cylinder 48 to operate.

The control valve 47 is provided on the bypass line 42a and is configured to control (open and close) the flow of oil. The control valve 47 opens or closes the bypass line 42a according to the operation of the pneumatic cylinder 48. When the control valve 47 is in the closed (off) state, the oil supplied from the hydraulic pump 45 is entirely supplied to the injection nozzle I along the hydraulic line 42 without leaking to the outside, thereby forming high pressure. On the other hand, when the control valve 47 is in the open (on) state, at least some or all of the oil supplied from the hydraulic pump 45 is returned to the oil tank 50 along the bypass line 42a to reduce or relieve the pressure in the hydraulic line 42. The control valve 47 may be configured to be operated by a pneumatic cylinder 48 as a conventional on-off valve.

The pneumatic cylinder 48 is operated by pneumatic pressure and is a driving means that physically opens and closes the control valve 47. The pneumatic cylinder 48 is connected to the second pneumatic line 41b and is configured to operate depending on the supply of air. That is, a rod advances or retracts by the pneumatic pressure introduced into the main body of the pneumatic cylinder 48, thereby operating the control valve 47. The pneumatic cylinder 48, which operates by pneumatic pressure, has a fast response speed, enabling control such as rapid removal of residual pressure after a test or immediate shutoff of hydraulic pressure in an emergency.

The oil pressure measuring portion 49 measures the pressure of the oil flowing within the hydraulic line 42. Specifically, the oil pressure measuring portion 49 measures the pressure of the oil supplied to the injection nozzle I.

The oil pressure measuring portion 49 is arranged in the hydraulic line 42. The oil pressure measuring portion 49 includes a digital display portion 49a and an analog display portion 49b.

The digital display portion 49a measures the real-time pressure of oil and digitally displays the peak value of the oil pressure supplied to the injection nozzle I.

The pressure of the oil supplied by the hydraulic pump 45 gradually increases and then decreases after the oil supplied to the injection nozzle I at the peak pressure is sprayed from the injection nozzle I. In this case, the digital display portion 49a displays the real-time pressure of the oil. However, when the oil pressure increases and then decreases, only the peak value is displayed, and the decreasing pressure is not displayed. To this end, the digital display portion 49a includes a peak-hold function. The peak-hold function digitally displays the rising pressure as it rises. However, when the pressure rises and then falls after reaching a peak, the falling pressure is not displayed, and only the peak pressure is displayed.

Typically, oil pressure rapidly drops simultaneously with spraying, making it difficult to accurately display the oil pressure (i.e., spray pressure) at the peak. The operator must continuously monitor the oil pressure. The operator must capture the moment when the oil pressure drops from the peak. When the peak value of the oil pressure is not accurately identified, further inspection must be performed. This delays the test time. The operator must continuously focus on the numbers or needles, which increases test fatigue.

In particular, it is difficult to precisely identify, with the naked eye, the moment when the oil pressure drops from the peak. In the present embodiment, by adding a peak-hold function to the digital display portion 49a, the precision for the peak value may be increased, operator fatigue may be reduced, and work time may be shortened.

The analog display portion 49b displays the oil pressure in real time by using a needle. The analog display portion 49b reflects both the increase and decrease in the oil pressure in real time. By arranging both the analog display portion 49b and the digital display portion 49a, the state of the oil pressure may be accurately identified. Furthermore, while the digital display portion 49a only displays the pressure up to the peak point of the oil, the analog display portion 49b displays the decreasing pressure in real time and displays the decreasing pressure with a needle, allowing the current status to be clearly identified.

By simultaneously referencing the air pressure displayed by the pneumatic pressure measuring portion 60, the peak oil pressure held on the digital display portion 49a, and the oil pressure change trend displayed in real time by the analog display portion 49b, the operator may intuitively identify the correlation between the pump operating conditions and the injection nozzle's spray characteristics. Accordingly, beyond simply checking the injection start pressure, complex abnormalities such as sticking of a needle valve inside the nozzle, minor oil leaks (dribbling), or abnormalities in the pump operating conditions may be diagnosed more reliably, resulting in a synergistic effect of significantly improving maintenance quality compared to when each component exists individually.

The test device 10 for an injection nozzle, according to the present disclosure has the following operational effects.

The test device 10 of the present disclosure performs testing by fixing one of the injection nozzles I stored in the plurality of storage grooves 22 to the inspection portion 33 and the grip portion 34 and then supplying oil to the fixed injection nozzle I.

Specifically, the first solenoid valve 43 is turned on to operate the hydraulic pump 45. When the hydraulic pump 45 operates, oil is supplied to the injection nozzle I along the hydraulic line 42. The digital display portion 49a measures the oil pressure in real time. When the oil pressure reaches a certain value, oil is sprayed from the injection nozzle I.

After the oil is sprayed, the oil pressure drops. The operator checks the oil pressure fixed on the digital display portion 49a. The operator evaluates whether the oil pressure checked by the digital display portion 49a is equal to a recommended pressure of the injection nozzle. When the oil pressure is equal to the recommended pressure of the injection nozzle or is within a certain range, the injection nozzle is indicated as normal. When the oil pressure differs from the recommended pressure of the injection nozzle or is outside the certain range, the injection nozzle is indicated as abnormal. For the injection nozzle indicated above, cleaning or replacement of the injection nozzle is performed.

The test device 10 according to the present disclosure performs testing by using the hydraulic pump 45, thereby enabling rapid and quick testing.

The test device 10 of the present disclosure operates the hydraulic pump 45 by using air pressure, thereby enabling rapid and accurate pump operation.

In the test device 10 of the present invention, the pressure at the time of spraying is digitally displayed and does not change even when the oil pressure drops due to a peak-hold function, and thus, there is no need for the operator to continuously check the state of the oil pressure.

The test device 10 of the present disclosure may detect abnormalities in the injection nozzle by using the hydraulic pump 45 operated by pneumatic pressure, enabling rapid and accurate testing.

The test device 10 for an injection nozzle, according to the present disclosure has the advantage of accurately identifying pressure changes by providing both the digital display portion 49a and the analog display portion 49b. Specifically, the combined use of the digital display portion 49a and analog display portion 49b allows for not only measuring an initial injection pressure but also simultaneously observing a pressure rise period and a pressure drop pattern immediately after injection.

That is, the digital display portion 49a reproducibly and consistently displays the peak pressure at the injection point, thereby quantitatively determining the nozzle's initial injection pressure (pop pressure). Meanwhile, the analog display portion 49b continuously displays subtle pressure fluctuations, pressure retention time after injection, and whether the pressure rises again immediately after injection, thereby allowing for visual identification of operating abnormalities, such as needle valve sticking, minor oil leaks (dribbling), and internal leakage.

Therefore, quantitative assessment and qualitative pattern analysis, which are difficult to achieve with either the digital display portion 49a or analog display portion 49b alone, are simultaneously possible, thereby enhancing the reliability of inspection results and the scope of diagnosis.

The test device 10 for an injection nozzle, according to the present disclosure may use the relief valve 44 installed in the first pneumatic line 41a, the bypass line 42a branched from the hydraulic line 42, and the pneumatic cylinder 48/control valve 47 that opens and closes the bypass line 42a, thereby stably controlling pressure conditions throughout the entire test cycle.

Specifically, the relief valve 44 limits the maximum pressure of the air supplied to the hydraulic pump 45 to a preset value, thereby ensuring that the pressure rise rate and peak pressure in each test are reproduced within a certain range. After injection is complete, the pneumatic cylinder 48, which operates through the same air supply line, opens the control valve 47 and thus rapidly release residual pressure in the hydraulic line 42 through the bypass line 42a and returns oil to the oil tank 50.

Because the pressure application and pressure release stages are continuously managed within a single pneumatic control system, the operator may perform repeated inspections under a nearly identical pressure history for each test without separate manual valve operation, and the risk of safety accidents due to residual high pressure is also reduced.

Furthermore, the test device 10 for an injection nozzle, according to the present disclosure may constantly monitor the driving pressure of the hydraulic pump 45 through the pneumatic pressure measuring portion 60, and upon completion of the test, operate the pneumatic cylinder 48 and the control valve 47 to open the bypass line 42a, thereby quickly releasing any remaining pressure in the hydraulic line 42.

In this way, the driving pressure measurement function by the pneumatic pressure measuring portion 60 and the automatic residual pressure relief function by the pneumatic cylinder 48 and control valve 47 may be organically combined to thereby achieve a complex effect of effectively preventing oil scattering and device damage due to excessive pressure accumulation or residual pressure, while also shortening the test preparation time for the next injection nozzle.

Furthermore, in the test device 10 according to the present disclosure, the relief valve 44, the pneumatic pressure measuring portion 60 arranged downstream thereof, and the pneumatically driven hydraulic pump 45 are organically connected to each other.

The operator may precisely set the air pressure applied to the hydraulic pump 45 to a target value by adjusting the relief valve 44 while checking the driving pressure displayed on the pneumatic pressure measuring portion 60. This allows the operator to stably manage the upper limit of the oil pressure generated in the hydraulic line 42. This provides the effect of ensuring the injection test conditions of the injection nozzle with high reproducibility in that the correlation between the air-side driving pressure and the oil-side test pressure may always be visualized, compared to cases where overpressure is simply limited by a relief valve.

Furthermore, the test device 10 according to the present disclosure uses the slide-type test body 30 supported by the plurality of storage grooves 22 formed on the support table 20 and the rail 23/slider 35, thereby establishing a process flow (line flow) capable of continuously inspecting multiple injection nozzles I on a single workbench.

That is, an injection nozzle I awaiting inspection may be stored in an aligned state in the storage groove 22, and the operator may take out the injection nozzle I from the storage groove 22, attach the injection nozzle I to the inspection portion 33/grip portion 34, and perform a test. After the test is completed, the test body 30 is retracted to a storage position so that preparation work for the next nozzle may be safely performed.

This configuration allows the transport, alignment, and fastening of the nozzle to be simultaneously performed on a table, even when performing a full inspection on an engine having multiple cylinders, such as an EDG. This reduces inspection time and handling accidents such as nozzle dropping and mixing.

As described above, the present disclosure is described with reference to an embodiment shown in the drawings, but this is only an example, and it would be understood by one of ordinary skill in the art that various modifications and modification of the embodiment may be made thereto. Therefore, the true scope of technical rights of the present disclosure should be determined by the technical ideas of the accompanying claims.

### EXPLANATION OF REFERENCE NUMERALS DESIGNATING THE MAJOR

10 . . . Test Device
20 . . . Support Table
21 . . . Wheel
22 . . . Storage Groove
23 . . . Rail
30 . . . Test Body
31 . . . Air Inlet Portion
32 . . . Discharge Portion
33 . . . Inspection Portion
34 . . . Grip Portion
35 . . . Slider
40 . . . Hydraulic System
41a . . . First Pneumatic Line
41b . . . Second Pneumatic Line
42 . . . Hydraulic Line
42a . . . Bypass Line
43 . . . First Solenoid Valve
44 . . . Relief Valve
45 . . . Hydraulic Pump
46 . . . Second Solenoid Valve
47 . . . Control Valve
48 . . . Pneumatic Cylinder
49 . . . Oil Pressure Measuring Portion
49a . . . Digital Display Portion
49b . . . Analog Display Portion
50 . . . Oil Tank

1. A test device for an injection nozzle of a nuclear power plant emergency generator configured to operate in an emergency situation of nuclear power generation, the test device comprising:
a support table;
a test body slidably installed on the support table and configured to slide between an inspection position and a storage position;
a hydraulic pump arranged within the test body and configured to operate by pneumatic pressure;
a first pneumatic line connecting an air inlet portion to the hydraulic pump and configured to supply air at a predetermined pressure to the hydraulic pump;
a relief valve arranged on the first pneumatic line and configured to control a maximum pressure of the air;
a hydraulic line configured to supply oil from the hydraulic pump to an injection nozzle; and
an oil pressure measuring portion configured to measure a pressure of the oil flowing within the hydraulic line,
wherein the oil pressure measuring portion comprises
a digital display portion configured to measure a real-time pressure of the oil and digitally display a peak value of the pressure of the oil supplied to the injection nozzle.

2. The test device of claim 1, wherein
the pressure of the oil supplied by the hydraulic pump gradually increases and then decreases after the oil supplied to the injection nozzle at a peak pressure is sprayed from the injection nozzle, and
the digital display portion displays the real-time pressure of the oil, and when the pressure of the oil increases and then decreases, only a peak value is displayed and a decreasing pressure is not displayed.

3. The test device of claim 2, wherein
the oil pressure measuring portion further comprises
an analog display portion configured to display the oil pressure in real time by using a needle,
wherein the analog display portion is configured to reflect all increases and decreases in the oil pressure in real time.

4. The test device of claim 1, wherein
a bypass line connected to an oil tank is connected to the hydraulic line, and a control valve configured to control the pressure of the oil is located in the bypass line.

5. The test device of claim 4, wherein
the control valve is connected to a pneumatic cylinder and is configured to be opened and closed.

6. The test device of claim 5, further comprising
a second pneumatic line connecting the air inlet portion to the pneumatic cylinder, wherein a second solenoid valve configured to selectively open and close air is provided in the second pneumatic line.

7. The test device of claim 1, wherein,
on the first pneumatic line,
a pneumatic pressure measuring portion configured to measure air pressure is provided.

8. The test device of claim 1, wherein
the test body comprises
a discharge portion connected to the hydraulic line and configured to discharge oil,
an inspection portion facing the discharge portion and configured to perform nozzle inspection, and
a grip portion arranged above the inspection portion, protruding from the test body, and configured to grip the injection nozzle.

9. The test device of claim 8, further comprising:
a rail provided on the support table and extending longitudinally in one direction; and
a slider arranged below the test body and slidably coupled to the rail.

10. The test device of claim 9, wherein
the support table has a plurality of storage grooves formed to accommodate a plurality of injection nozzles.

11. The test device of claim 1, wherein
a pneumatic pressure measuring portion is provided between the relief valve and the hydraulic pump on the first pneumatic line to measure a driving pneumatic pressure applied to the hydraulic pump through the relief valve, and
a bypass line connected to an oil tank and a control valve configured to open and close the bypass line are provided in the hydraulic line, and the control valve is installed to be driven by a pneumatic cylinder connected to a second pneumatic line,
wherein the relief valve is configured to control the pressure of air supplied to the hydraulic pump to limit an upper limit of an oil discharge pressure, the pneumatic pressure measuring portion provides a reference value for pressure control by indicating an actual driving pneumatic pressure of the air that passed through the relief valve, and the pneumatic cylinder is configured to open the control valve when pneumatic pressure is supplied through the second pneumatic line, thereby forcibly relieving residual pressure in the hydraulic line and retrieving oil.
